(19) United States
(12) Patent Application Publication
(10) Pub. No.: US 2025/0253598 A1
(43) Pub. Date: Aug. 7, 2025

(54) RELAY CONNECTOR AND CONNECTOR ASSEMBLY

(71) Applicant: HIROSE ELECTRIC CO., LTD., Kanagawa (JP)

(72) Inventor: Shinnosuke MIWA, Kanagawa (JP)

(21) Appl. No.: 19/026,986

(22) Filed: Jan. 17, 2025

(30) Foreign Application Priority Data
Feb. 6, 2024 (JP) 2024-016298

(51) Int. Cl. H01R 13/74; H01R 13/518

(52) U.S. Cl. CPC H01R 13/743; H01R 13/518

(57) ABSTRACT

Provided is a relay connector to be mounted on a casing of an electronic apparatus, the relay connector including: a housing; an unbranched terminal; and a branched terminal, in which the housing includes one inner mating port and n outer mating ports, one contact portion of the unbranched terminal is located in the one inner mating port, and the other contact portion of the unbranched terminal is located in any of the n outer mating ports, and one contact portion of the branched terminal is located in the one inner mating port, and the n-branched other contact portions of the branched terminal are located in associating ones of the n outer mating ports respectively.

### CROSS-REFERENCE TO RELATED APPLICATION

This application claims priority from Japanese Patent Application No. 2024-016298 filed with the Japan Patent Office on Feb. 6, 2024, the entire content of which is hereby incorporated by reference.

### BACKGROUND

### 1. Technical Field

The present disclosure relates to a relay connector and a connector assembly.

### 2. Related Art

Generally, a casing panel of an electronic apparatus is provided with a relay connector to connect an internal device inside the casing panel and an external device outside the casing panel (refer to, for example, JP-A-2014-127429). In JP-A-2014-127429, the casing panel is formed with an opening, and the relay connector is mounted in the opening of the casing panel. The relay connector is formed with a mating port on each of the inside and outside of the casing panel. An internal connector for the internal device is mated to the mating port on the inside of the casing panel. An external connector for the external device is mated to the mating port on the outside of the casing panel. Terminals of the internal connector and terminals of the external connector are electrically connected one-on-one via terminals of the relay connector.

### SUMMARY

A relay connector according to the present disclosure is to be mounted on a casing of an electronic apparatus, the relay connector including: a housing; an unbranched terminal; and a branched terminal, in which the housing includes one inner mating port and n outer mating ports, one contact portion of the unbranched terminal is located in the one inner mating port, and the other contact portion of the unbranched terminal is located in any of the n outer mating ports, and one contact portion of the branched terminal is located in the one inner mating port, and the n-branched other contact portions of the branched terminal are located in associating ones of the n outer mating ports respectively.

### BRIEF DESCRIPTION OF THE DRAWINGS

FIG. 1 is a perspective view of connectors of the embodiment as viewed from outside a casing;

FIG. 2 is a perspective views of the connectors of the embodiment as viewed from inside the casing;

FIGS. 3A and 3B are perspective views of an internal connector of the embodiment;

FIGS. 4A and 4B are perspective views of an external connector of the embodiment;

FIGS. 5A and 5B are perspective views of a relay connector of the embodiment; FIG. 6 is a rear view of the relay connector of the embodiment;

FIGS. 7A to 7C are cross-sectional views of the relay connector of the embodiment; and

FIGS. 8A and 8B are perspective views illustrating connected states of terminals for power lines and for signal lines of the embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, the electronic apparatus described in JP-A-2014-127429 has a problem that the numbers of relay connectors and wires increase according to the number of external device connections.

The present disclosure has been made in view of such a point, and an object thereof is to provide a relay connector and a connector assembly, which can reduce the numbers of connectors and wires if a plurality of external devices is connected.

A relay connector according to an aspect of the present disclosure is to be mounted on a casing of an electronic apparatus, the relay connector including: a housing; an unbranched terminal; and a branched terminal, in which the housing includes one inner mating port and n outer mating ports, one contact portion of the unbranched terminal is located in the one inner mating port, and the other contact portion of the unbranched terminal is located in any of the n outer mating ports, and one contact portion of the branched terminal is located in the one inner mating port, and the n-branched other contact portions of the branched terminal are located in associating ones of the n outer mating ports respectively.

A connector assembly according to an aspect of the present disclosure includes: a relay connector to be mounted on a casing of an electronic apparatus; one internal connector placed inside the casing; and n external connectors placed outside the casing, in which the relay connector connects the internal connector and the external connectors, and includes a housing, an unbranched terminal, and a branched terminal, the housing includes one inner mating port to be mated to the one internal connector, and n outer mating ports to be mated to the n external connectors, one contact portion of the unbranched terminal is located in the one inner mating port, and the other contact portion of the unbranched terminal is located in any of the n outer mating ports, one contact portion of the branched terminal is located in the one inner mating port, and the n-branched other contact portions of the branched terminal are located in associating ones of the n outer mating ports respectively, and the unbranched terminal connects a terminal of the one internal connector and a terminal of any of the n external connectors one-on-one, and the branched terminal connects a terminal of the one internal connector and terminals of the n external connectors one-on-n.

According to the present disclosure, the one internal connector is mated to the one inner mating port of the relay connector, and the n external connectors are mated to the n outer mating ports of the relay connector (n is an integer equal to or greater than two). One relay connector connects the one internal connector and the n external connectors and therefore the number of connectors can be reduced. Moreover, the terminal of the one internal connector and the terminal of one external connector are electrically connected one-on-one via the unbranched terminal, and the terminal of the one internal connector and the terminals of the n external connectors are electrically connected one-on-n via the branched terminal. Consequently, the number of wires to be connected to the internal connector can be reduced.

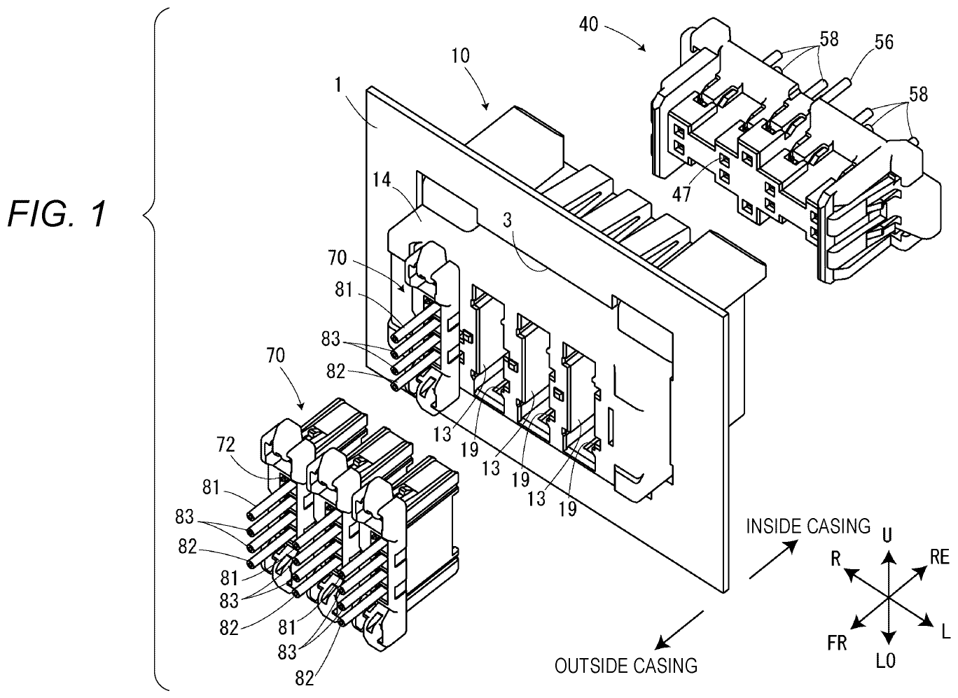

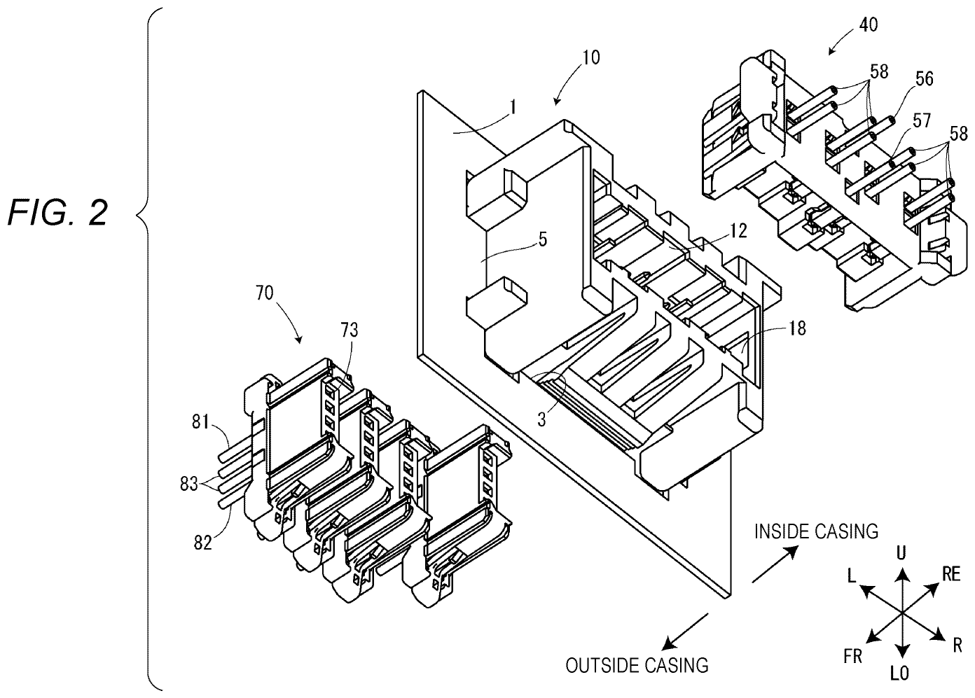

A connector assembly including a relay connector, an internal connector, and an external connector of the embodiment is described below. FIG. 1 is a perspective view of the connectors of the embodiment as viewed from outside a casing. FIG. 2 is a perspective view of the connectors of the embodiment as viewed from inside the casing. In the following description, a description is given, assuming that the internal connector side is inside (the inside of/inward of) the casing and the external connector side is outside (the outside of/outward of) the casing, across a panel of the casing. Moreover, in the drawings, an arrow FR indicates the front side of the relay connector, an arrow RE indicates the rear side of the relay connector, an arrow U indicates the upper side of the relay connector, an arrow LO indicates the lower side of the relay connector, an arrow L indicates the left side of the relay connector, and an arrow R indicates the right side of the relay connector.

As illustrated in FIGS. 1 and 2, one relay connector 10 is mounted on a panel 1 of a casing of an electronic apparatus. In the embodiment, the one relay connector 10 connects one internal connector 40 placed inside the casing, and four external connectors 70 placed outside the casing. Note that FIG. 1 illustrates a state where one of the four external connectors is mated to the relay connector.

A rear part of a housing 11 of the relay connector 10 protrudes inward of the casing from the panel 1, and the rear part of the housing 11 inside the casing is formed with one inner mating port 12 for the internal connector 40. A front part of the housing 11 of the relay connector 10 protrudes outward of the casing from the panel 1, and the front part of the housing 11 outside the casing is formed with four outer mating ports 13 for the external connectors 70.

The one internal connector 40 is provided at distal ends of one positive power line 56, one negative power line 57, and eight signal lines 58, which extend from an internal device (not illustrated) inside the casing. The four external connectors 70 are each provided at distal ends of one positive power line 81, one negative power line 82, and two signal lines 83, which extend from an associated one of four external devices (not illustrated) outside the casing.

The one internal connector 40 is mated to the one inner mating port 12 of the relay connector 10, and the four external connectors 70 are mated to the four outer mating ports 13 of the relay connector 10 respectively. As a result, the one internal device and the four external devices are electrically connected. For example, the internal device is a control device, and the external devices are various sensors.

In this manner, the four external connectors 70, the one internal connector 40, and the one relay connector 10 form the connector assembly. The four external connectors 70 are connected to the one internal connector 40 via the one relay connector 10. Therefore, space savings are promoted and the number of connectors is reduced as compared to a configuration where an external connector and an internal connector are provided for each external apparatus. Moreover, the four positive power lines 81 outside the casing converge into the one positive power line 56 inside the casing via the relay connector 10. The four negative power lines 82 outside the casing converge into the one negative power line 57 inside the casing via the relay connector 10. The four positive power lines 81 and the four negative power lines 82 outside the casing converge into the positive power line 56 and the negative power line 57 inside the casing, respectively. A reduction in the number of wires can be achieved accordingly.

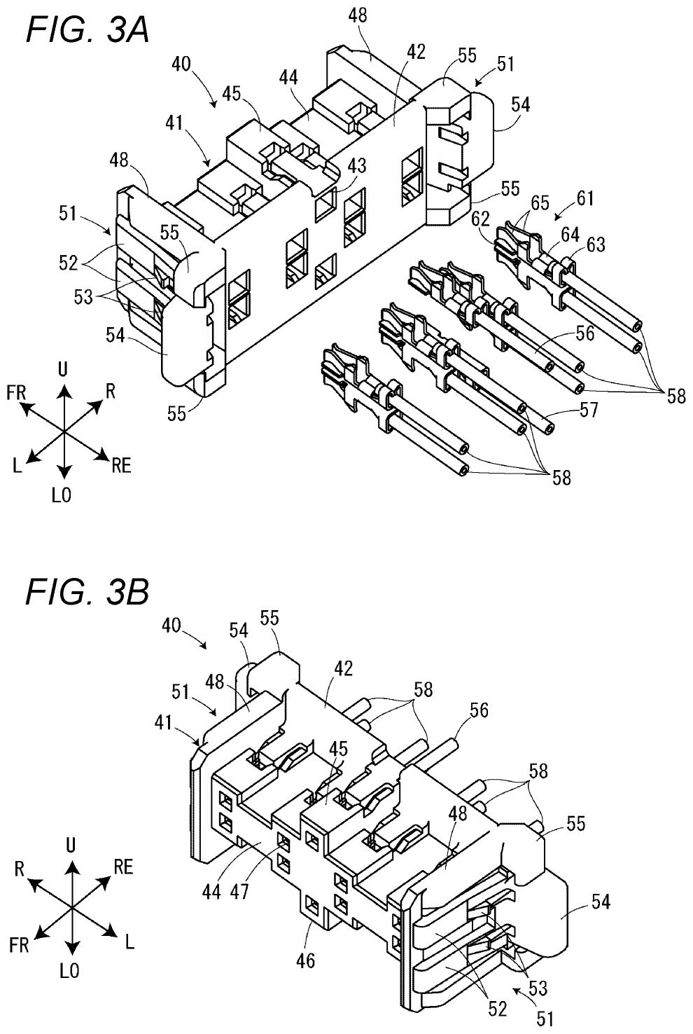

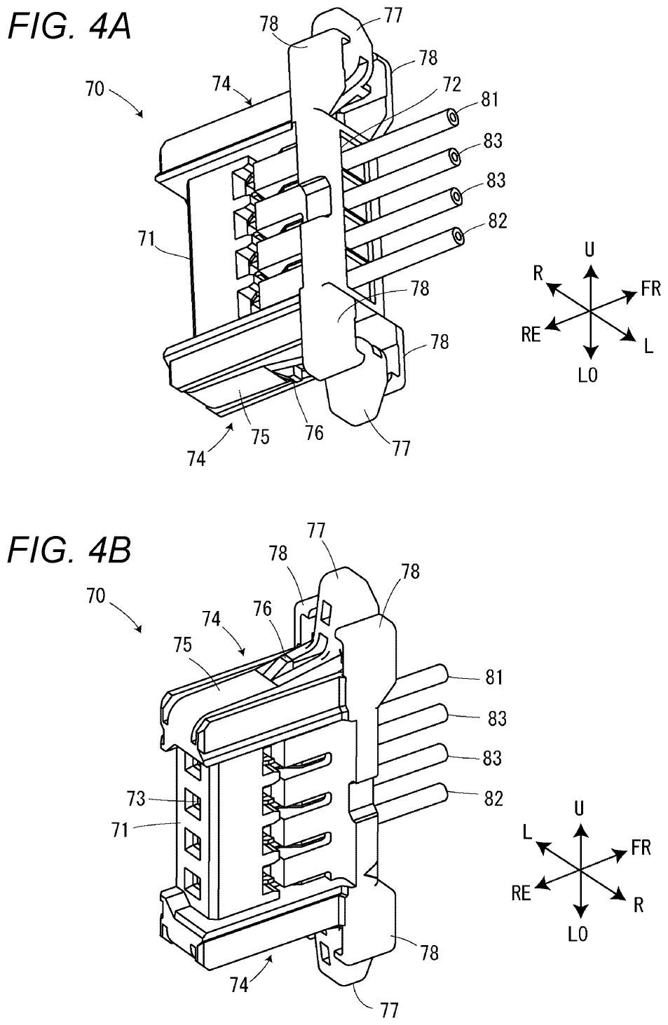

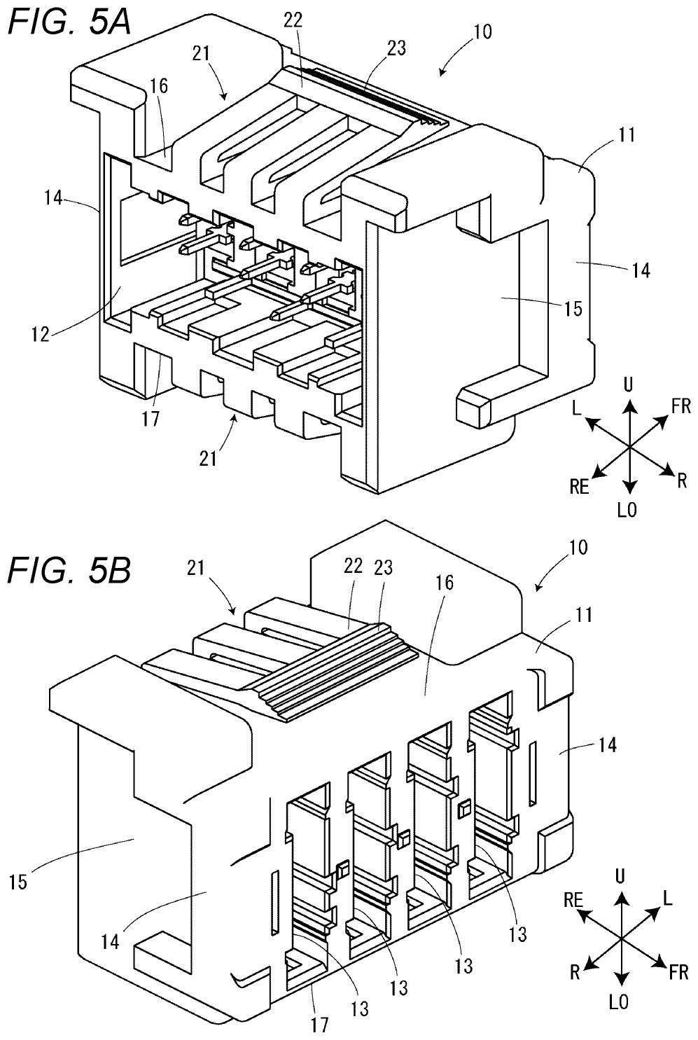

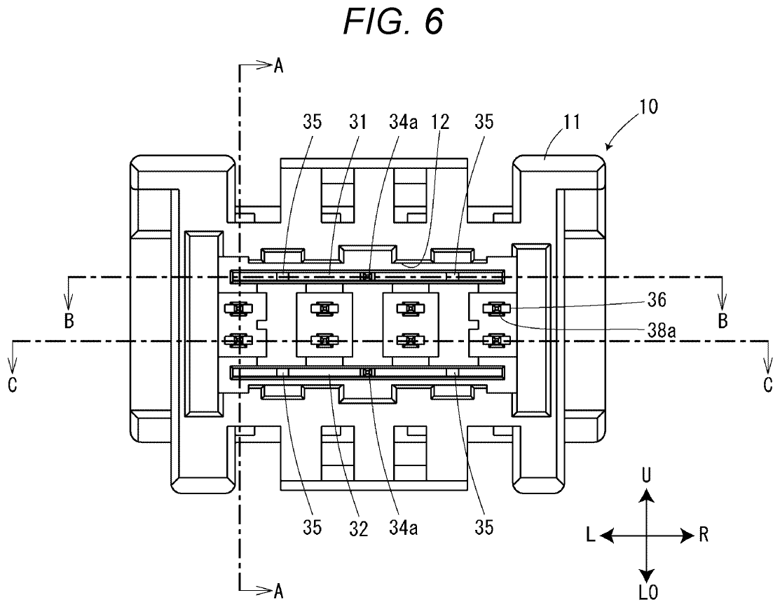

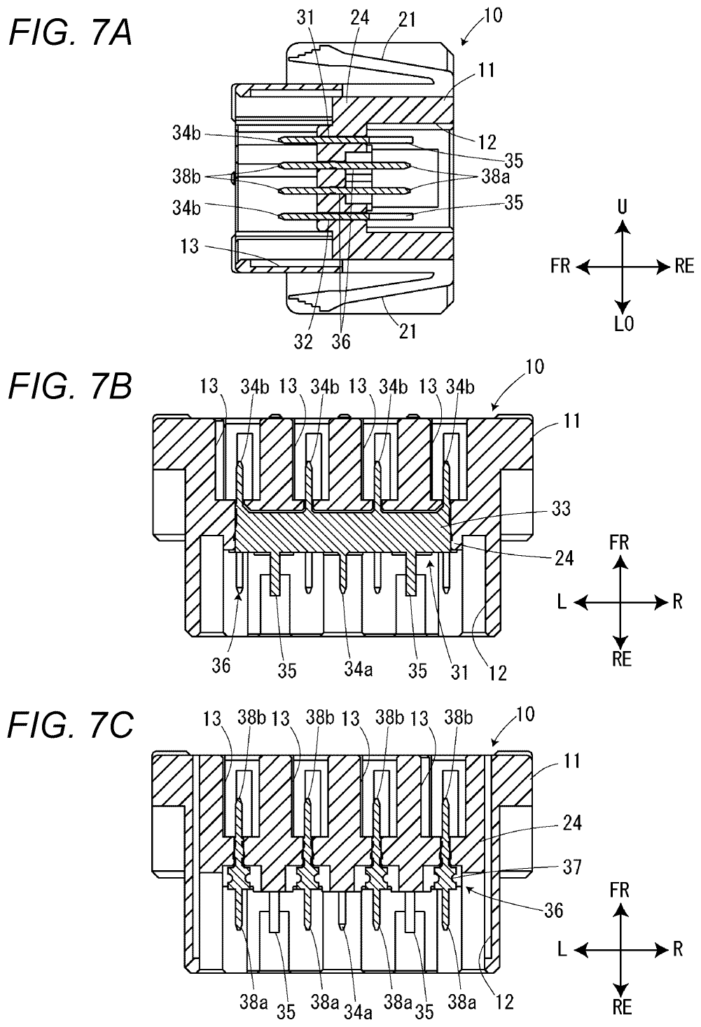

The configurations of the internal connector 40, the external connectors 70, and the relay connector 10 are described below. FIGS. 3A and 3B are perspective views of the internal connector 40 of the embodiment. FIGS. 4A and 4B are perspective views of the external connector 70 of the embodiment. FIGS. 5A and 5B are perspective views of the relay connector 10 of the embodiment. FIG. 6 is a rear view of the relay connector 10 of the embodiment. FIGS. 7A to 7C are cross-sectional views of the relay connector of the embodiment. Note that FIG. 3A illustrates the internal connector 40 as viewed from inside the casing. FIG. 3B illustrates the internal connector 40 as viewed from outside the casing. FIG. 5A illustrates the relay connector 10 as viewed from inside the casing. FIG. 5B illustrates the relay connector 10 as viewed from outside the casing. FIG. 7A illustrates a cross section of a rear surface of the relay connector 10, taken along line A-A. FIG. 7B illustrates a cross section of the rear surface of the relay connector 10, taken along line B- B. FIG. 7C illustrates a cross section of the rear surface of the relay connector 10, taken along line C-C.

As illustrated in FIGS. 3A and 3B, the internal connector 40 is a ten-conductor socket to which the one positive power line 56, the one negative power line 57, and the eight signal lines 58 are connected. The internal connector 40 includes a resin housing 41. A rear wall 42 of the housing 41 is formed with a plurality of terminal accommodation holes 43. One terminal accommodation hole 43 in the upper middle of the rear wall 42 accommodates a terminal 61 (one terminal) of the positive power line 56, and one terminal accommodation hole 43 in the lower middle of the rear wall 42 accommodates a terminal 61 (the one terminal) of the negative power line 57. Eight terminal accommodation holes 43 are aligned in two upper and lower rows in the middle of the rear wall 42 in an up-and- down direction. The eight terminal accommodation holes 43 aligned in the two upper and lower rows accommodate terminals 61 of the eight signal lines 58 aligned in two upper and lower rows, respectively.

A housing body 44 is connected to a front side of the rear wall 42 of the housing 41. The outer shape of the housing body 44 matches the formation area of the plurality of terminal accommodation holes 43. A middle part on an upper part of the housing body 44 protrudes upward to form an upper protruding portion 45, and a middle part on a lower part of the housing body 44 protrudes downward to form a lower protruding portion 46. A front surface of the upper protruding portion 45 is formed with one contact insertion hole 47, and a front surface of the lower protruding portion 46 is formed with one contact insertion hole 47. A middle part of the housing body 44 in the up-and-down direction is formed with eight contact insertion holes 47 in two upper and lower rows. The contact insertion holes 47 are connected to the terminal accommodation holes 43 respectively.

Two side surfaces of the housing body 44 are connected to a pair of side walls 48. The pair of side walls 48 is provided with a pair of cantilever spring-shaped side locks 51. Arms 52 of the side locks 51 extend rearward from a front end of the housing 41, and lock portions 53 located halfway in the extension direction of the arms 52 enter indentations 18 (refer to FIG. 2) in the inner mating port 12 of the relay connector 10 to be locked. A distal end of the arm 52 of each of the side locks 51 is provided with an operating portion 54. The operating portions 54 are pressed and therefore the lock portions 53 are disengaged from the indentations in the inner mating port 12 to release the locks. Moreover, a latching portion 55 that restricts the amount of shaking of its associated arm 52 is provided at each of upper and lower end portions of its associated side wall 48.

The wires including the positive power line 56, the negative power line 57, and the signal lines 58 are connected to the same terminals 61 respectively. Each of the terminals 61 is formed of a conductive material such as a copper alloy. A base plate 62 of the each of the terminals 61 extends along its associated wire, and a sheath crimping portion 63, a conductor crimping portion 64, and a pair of contact pieces 65 are formed from a proximal end toward a distal end of each of the base plates 62. Sheaths of the wires are crimped by the sheath crimping portions 63, and conductors jutting out from the sheaths of the wires are crimped by the conductor crimping portions 64. As a result, the terminals 61 are connected to the wires respectively. Each pair of contact pieces 65 faces each other in a left-and right direction, and the each pair of contact pieces 65 forms a clip-shaped contact portion.

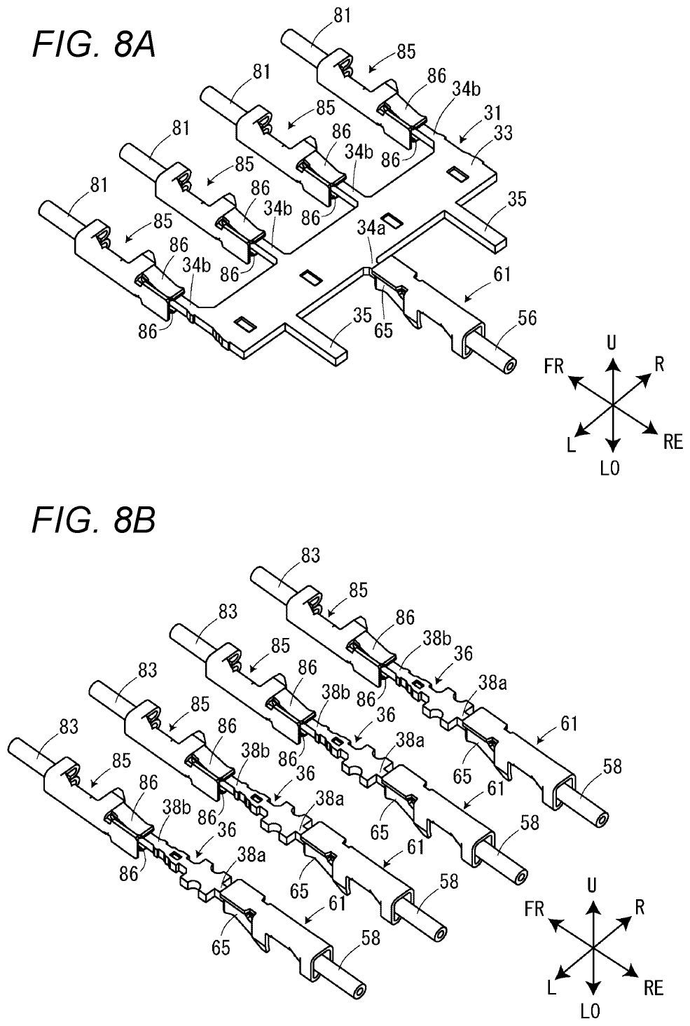

As illustrated in FIGS. 4A and 4B, the external connector 70 is a four-conductor socket to which the one positive power line 81, the one negative power line 82, and the two signal lines 83 are connected. The external connector 70 includes a resin housing 71. A front part of the housing 71 is formed with four terminal accommodation holes 72 aligned vertically. The first terminal accommodation hole 72 from the top accommodates a terminal 85 (the other terminal) (refer to FIGS. 8A and 8B) of the positive power line 81, the fourth terminal accommodation hole 72 from the top accommodates a terminal 85 (the other terminal) of the negative power line 82. The second and third terminal accommodation holes 72 from the top accommodate terminals 85 of the two signal lines 83 respectively. A rear part of the housing 71 is formed with four contact insertion holes 73 aligned vertically. The contact insertion holes 73 are connected to the terminal accommodation holes 72 respectively.

Upper and lower parts of the housing 71 are provided with a pair of cantilever spring-shaped side locks 74. Arms 75 of the side locks 74 extend forward from a rear end of the housing 71, and lock portions 76 located halfway in the extension direction of the arms 75 enter indentations 19 (refer to FIG. 1) in the outer mating port 13 of the relay connector 10 to be locked. A distal end of the arm 75 of each of the side locks 74 is provided with an operating portion 77. The operating portions 77 are pressed and therefore the lock portions 76 are disengaged from the indentations in the outer mating port 13 to release the locks. A latching portion 78 that restricts the amount of shaking of its associated arm 75 is provided at each of upper and lower end portions of the housing 71. Note that the wires of the external connector 70 are connected to the same terminals 85 (refer to FIGS. 8A and 8B) as those of the wires of the internal connector 40, respectively.

As illustrated in FIGS. 5A and 5B, the relay connector 10 includes the resin housing 11. The rear part of the housing 11 is formed with the one inner mating port 12, and the front part of the housing 11 is formed with the four outer mating ports 13. Each of a pair of side walls 14 of the housing 11 is formed with a recessed portion 15 created by a rear side of a front end portion of the side wall 14 being set back further than other parts. A pair of projecting pieces 5 (refer to FIG. 2) of the panel 1 of the casing fits in the recessed portions 15 of the pair of side walls 14. The side walls 14 of the housing 11 are caught on the pair of projecting pieces 5 to restrict the amount of insertion of the relay connector 10 into an opening 3 (refer to FIG. 2) of the panel 1.

An exterior wall of the housing 11 is provided with a pair of cantilever spring-shaped mounting pieces 21. In the embodiment, an upper wall 16 and a bottom wall 17 of the housing 11 are provided with the pair of cantilever spring-shaped mounting pieces 21. The mounting pieces 21 extend forward from a rear end of the housing 11, and a distal end of each of the mounting pieces 21 is provided with an abutting portion 22 that abuts on an opening edge of the panel 1. Each of the abutting portions 22 is formed with a stepped slope 23 of which the height increases in stages in a direction opposite to a direction in which the housing 11 is mounted on the panel 1, that is, a direction from the front to the rear of the housing 11. The stepped slopes 23 are pressed against the opening edge of the panel 1 to prevent the housing 11 from coming out of the opening 3 of the panel 1. The stepped slopes 23 are each pressed at an appropriate position according to the thickness of the panel 1. Therefore, the same relay connector 10 can be used for the panels 1 having different thicknesses.

As illustrated in FIGS. 6 and 7A, the housing 11 is formed with a center wall 24 that divides the inner mating port 12 from the four outer mating ports 13. A positive power terminal 31, a negative power terminal 32, and signal terminals 36 are mounted on the center wall 24 of the housing 11. The plate-shaped positive power terminal 31 is held in a horizontally long holding hole in an upper part of the center wall 24, and the plate-shaped negative power terminal 32 is held in a horizontally long holding hole in a lower part of the center wall 24. Eight holding holes are aligned in two upper and lower rows in a middle part of the center wall 24 in the up-and-down direction. Eight pin-shaped signal terminals 36 aligned in two upper and lower rows are held in the eight holding holes aligned in the two upper and lower rows. In this manner, the eight signal terminals 36 are installed in a space in the up-and-down direction between the positive power terminal 31 and the negative power terminal 32 in the housing 11.

The inner mating port 12 of the housing 11 is larger than each of the outer mating ports 13. The housing 11 is formed in such a manner that the positive power terminal 31, the negative power terminal 32, and the signal terminals 36 can be inserted through the inner mating port 12. The positive power terminal 31, the negative power terminal 32, and the signal terminals 36 can be inserted into the housing 11 through the inner mating port 12, and therefore can be mounted in the same direction in the housing 11 regardless of the sizes of the terminals. Particularly, the inner mating port 12 is larger than the each of the outer mating ports 13 and therefore the signal terminals 36 can be easily inserted through the inner mating port 12 as compared to a configuration where the signal terminals 36 are inserted through the outer mating ports 13.

As illustrated in FIGS. 6 and 7B, the positive power terminal 31 is a branched terminal including one contact portion 34a (one contact portion) that is located in the one inner mating port 12, and four branched contact portions 34b (the other contact portions) that are located in the four outer mating ports 13 respectively. The positive power terminal 31 is formed with a plate-shaped base portion 33 that is inserted into the holding hole in the housing 11 (the center wall 24). The one contact portion 34a protrudes from the base portion 33 into the inner mating port 12 and is formed in a pin shape. The four contact portions 34b protrude from the base portion 33 into the outer mating ports 13 and are each formed in a pin shape. In this manner, the positive power terminal 31 including the one contact portion 34a and the four branched contact portions 34b is formed in a simple shape.

A pair of holding pieces 35 protrudes from the base portion 33 into the inner mating port 12 on both of the left and right sides of the one contact portion 34a. When the positive power terminal 31 is inserted into the holding hole in the housing 11, the pair of holding pieces 35 is held by a jig for mounting. The holding of the pair of holding pieces 35 by the jig allows the positive power terminal 31 to be inserted into the holding hole in the housing 11 without the jig damaging the contact portion 34a. Moreover, upon manufacture of the positive power terminal 31, the pair of holding pieces 35 is connected to a carrier (not illustrated), and the contact portion 34a is not connected to the carrier. Hence, burrs are not formed on the contact portion 34a when the positive power terminal 31 is separated from the carrier. Note that although a description is omitted, the negative power terminal 32 is also formed as in the positive power terminal 31.

As illustrated in FIGS. 6 and 7C, each of the signal terminals 36 is an unbranched terminal including a contact portion 38a (one contact portion) located in the one inner mating port 12, and a contact portion 38b (the other contact portion) located in its associated one of the four outer mating ports 13. The each of the signal terminals 36 is formed with a plate-shaped widened portion 37 that is brought into contact with the center wall 24 in the inner mating port 12. One contact portion 38a extending inward of the casing from each of the widened portions 37 is formed in a pin shape, and one contact portion 38b extending outward of the casing from the each of the widened portions 37 is formed in a pin shape. The contact portions 38a, together with the widened portions 37, are located in the inner mating port 12, and the contact portions 38b penetrate the holding holes in the center wall 24 and protrude into the outer mating ports 13.

In the embodiment, the positive power terminal 31 and the negative power terminal 32 are a pair of branched terminals spaced apart from each other in the up-and-down direction of the housing 11. The signal terminals 36 being a plurality of unbranched terminals are located in the up-and-down direction of the housing 11 between the pair of branched terminals (between the positive power terminal 31 and the negative power terminal 32).

The contact portion 38a, which is the one contact portion, of each of the signal terminals 36 being the unbranched terminals is located in the one inner mating port 12. The contact portion 38b, which is the other contact portion, of the each of the signal terminals 36 is located in its associated one of the n (four in the embodiment) outer mating ports 13.

The contact portions 34a, which are the one contact portions, of the positive power terminal 31 and the negative power terminal 32, which are the branched terminals, are located in the one inner mating port 12. The contact portions 34b, which are the other contact portions, of the positive power terminal 31 and the negative power terminal 32 each branch into n (four in the embodiment), and are located in their associated n outer mating ports 13 respectively.

A connected state of terminals is described with reference to FIGS. 1, 2, 8A and 8B. FIGS. 8A and 8B are perspective views illustrating connected states of the terminals for the power lines and for the signal lines of the embodiment. Note that FIG. 8A illustrates the connected state of the terminals for the power lines, and FIG. 8B illustrates the connected state of the terminals for the signal lines. The connectors are omitted in FIGS. 8A and 8B for convenience of description.

As illustrated in FIG. 2, when the internal connector 40 is mated to the inner mating port 12 of the relay connector 10, the pin-shaped contact portion 34a of the positive power terminal 31 is inserted into the contact insertion hole 47 of the internal connector 40. The contact portion 34a of the positive power terminal 31 protrudes into the terminal accommodation hole 43 of the internal connector 40 through the contact insertion hole 47. The contact portion 34a enters between the pair of contact pieces 65 of the terminal 61 installed in the terminal accommodation hole 43. As illustrated in FIG. 8A, the contact portion 34a of the positive power terminal 31 is then sandwiched between the pair of contact pieces 65 of the terminal 61, and the terminal 61 connected to the positive power line 56 of the internal connector 40 is electrically connected to the positive power terminal 31 of the relay connector 10.

As illustrated in FIG. 1, when the four external connectors 70 are mated to the four outer mating ports 13 of the relay connector 10, the four pin-shaped contact portions 34b of the positive power terminal 31 are inserted into the contact insertion holes 73 of the four external connectors 70. The contact portions 34b of the positive power terminal 31 protrude into the terminal accommodation holes 72 of the external connectors 70 through the contact insertion holes 73. Each of the contact portions 34b enters between a pair of contact pieces 86 of the terminal 85 installed in its associated terminal accommodation hole 72. As illustrated in FIG. 8A, the each of the contact portions 34b of the positive power terminal 31 is then sandwiched between the pair of contact pieces 86 of the terminal 85, and the terminals 85 connected to the positive power lines 81 of the external connectors 70 are electrically connected to the positive power terminal 31 of the relay connector 10.

The contact portion on an external connector 70 side (on the outside of the casing) of the positive power terminal 31 branches into the four contact portions 34b. Therefore, the terminal 61 of the one internal connector 40 is connected one-on-four to the terminals 85 of the four external connectors 70 via the positive power terminal 31. Moreover, the pair of holding pieces 35 of the positive power terminal 31 protrudes into the inner mating port 12. However, the upper part of the housing body 44 of the internal connector 40 is recessed except the upper protruding portion 45, and the upper part of the housing body 44 does not interfere with the pair of holding pieces 35. Note that the negative power terminal 32 is also similarly and electrically connected to the terminals 61 and 85 connected to the negative power lines 57 and 82 of the internal connector 40 and the external connector 70.

As illustrated in FIG. 2, when the internal connector 40 is mated to the inner mating port 12 of the relay connector 10, the pin-shaped contact portions 38a of the signal terminals 36 are inserted into the contact insertion holes 47 of the internal connector 40. The contact portions 38a of the signal terminals 36 protrude into the terminal accommodation holes 43 of the internal connector 40 through the contact insertion holes 47. Each of the contact portions 38a enters between the pair of contact pieces 65 of the terminal 61 installed in its associated terminal accommodation hole 43. As illustrated in FIG. 8B, the contact portion 38a of each of the signal terminals 36 is then sandwiched between the pair of connect pieces 65 of its associated terminal 61, and the terminals 61 connected to the signal lines 58 of the internal connector 40 are electrically connected to the signal terminals 36 of the relay connector 10.

As illustrated in FIG. 1, when the four external connectors 70 are mated to the four outer mating ports 13 of the relay connector 10, the pin-shaped contact portions 38b of the signal terminals 36 are inserted into the contact insertion holes 73 of the external connectors 70 respectively. The contact portions 38b of the signal terminals 36 protrude into the terminal accommodation holes 72 of the external connectors 70 through the contact insertion holes 73. Each of the contact portions 38b enters between the pair of contact pieces 86 of the terminal 85 installed in its associated terminal accommodation hole 72. As illustrated in FIG. 8B, the contact portion 38b of the each of the signal terminals 36 is then sandwiched between the pair of contact pieces 86 of its associated terminal 85, and the terminals 85 connected to the signal lines 83 of the external connectors 70 are electrically connected to the signal terminals 36 of the relay connector 10.

The signal terminals 36 branch on neither the internal connector 40 side nor the external connector 70 side. Hence, the terminals 61 of the internal connector 40 are connected one-on-one to the terminals 85 of the external connectors 70 via the signal terminals 36. In this manner, the ten-conductor internal connector 40 and the four four-conductor external connectors 70 are connected via the one relay connector 10. The numbers of the signal lines 58 and 83 are not different between the internal connector 40 and the external connector 70. However, the numbers of the positive power lines 56 and the negative power lines 57 of the internal connector 40 are each reduced by three as compared to the numbers of the positive power lines 81 and the negative power lines 82 of the external connectors 70. Moreover, the number of the relay connectors 10 required is one. Therefore, the panel 1 of the casing is simply required to have an opening in only one place.

As described above, according to the embodiment, the one internal connector 40 is mated to the one inner mating port 12 of the relay connector 10, and the four external connectors 70 are mated to the four outer mating ports 13 of the relay connector 10. The one internal connector 40 and the four external connectors 70 are connected by the one relay connector 10 and therefore the number of connectors can be reduced. Moreover, the terminal 61 of the one internal connector 40 is electrically connected one-on-one to the terminal 85 of one external connector 70 via the signal terminal 36, and the terminals 61 of the one internal connector 40 are electrically connected one-on-four to the terminals 85 of the four external connectors 70 via the positive power terminal 31 and the negative power terminal 32. The positive power terminal 31 and the negative power terminal 32 connect the terminals one-on-four; therefore, the number of wires connected to the internal connector 40 can be reduced.

Note that in the embodiment, the contact portion on the external connector side of each of the positive power terminal and the negative power terminal branches into four. However, the contact portion on the external connector side of the each of the positive power terminal and the negative power terminal may branch into n (n is an integer equal to or greater than two). In this case, n external connectors are connected to n outer mating ports of the relay connector.

Moreover, in the embodiment, the positive power terminal and the negative power terminal are each formed in a shape including: one pin-shaped terminal protruding from the plate-shaped base portion toward the internal connector; and four pin-shaped terminals protruding toward the external connector. However, the shape of the positive power terminal and the negative power terminal is not limited. The positive power terminal and the negative power terminal are simply required to be formed in such a manner that the terminals of the internal connector can be connected one-on-n to the terminals of the n external connectors.

Moreover, in the embodiment, the signal terminals are each formed in a straight shape. However, the shape of the signal terminals is not limited. The signal terminals are simply required to be formed in such a manner that the terminals of the internal connector can be connected one-on-one to the terminals of the n external connectors.

According to a first aspect of the present disclosure, a relay connector (10) is to be mounted on a casing of an electronic apparatus, the relay connector including: a housing; an unbranched terminal (signal terminal 36); and a branched terminal (positive power terminal 31, a negative power terminal 32), in which the housing includes one inner mating port (12) and n outer mating ports (13), one contact portion (38a) of the unbranched terminal is located in the one inner mating port, and the other contact portion (38b) of the unbranched terminal is located in any of the n outer mating ports, and one contact portion (34a) of the branched terminal is located in the one inner mating port, and the n-branched other contact portions (34b) of the branched terminal are located in associating ones of the n outer mating ports respectively.

According to a second aspect of the present disclosure, in the first aspect, the unbranched terminal is a signal terminal and the branched terminal is a power terminal. According to this configuration, the number of power lines connected to an internal connector can be reduced.

According to a third aspect of the present disclosure, in the first or second aspect, an exterior wall of the housing is provided with a cantilever spring-shaped mounting piece (21), a distal end of the cantilever spring-shaped mounting piece is formed with a stepped slope of which the height increases in stages in a direction opposite to a direction in which the housing is mounted on the casing, and it is configured in such a manner that upon mounting the housing on the casing, the stepped slope is pressed against an opening edge of an opening provided to the casing to prevent the housing from coming out of the opening. According to this configuration, the stepped slope is pressed at an appropriate position according to the thickness of the casing (panel). Therefore, the same relay connector can be used for casings having different thicknesses.

According to a fourth aspect of the present disclosure, in any one of the first to third aspects, the branched terminal includes a plate-shaped base portion (33) to be inserted into the housing, and the one contact portion of the branched terminal is formed in a pin shape protruding from the base portion into the inner mating port, and the other contact portions of the branched terminal are formed in a pin shape protruding from the base portion into the outer mating ports. According to this configuration, the branched terminal including the n-branched other contact portions is formed in a simple shape.

According to a fifth aspect, in the fourth aspect, the base portion includes a pair of holding pieces (35) protruding from the base portion into the inner mating port, and it is configured in such a manner that upon inserting the branched terminal into the housing, the pair of holding pieces is held by a jig for mounting. According to this configuration, the pair of holding pieces is held by the jig. Therefore, the branched terminal can be inserted into the housing without damaging the one contact portion of the branched terminal.

According to a sixth aspect of the present aspect, in any one of the first to fourth aspects, the branched terminal is a pair of branched terminals disposed spaced apart from each other in an up-and-down direction of the housing, and the unbranched terminal is a plurality of unbranched terminals located between the pair of branched terminals in the up-and-down direction of the housing. According to this configuration, the plurality of unbranched terminals can be installed by use of a space between the pair of branched terminals.

According to a seventh aspect of the present aspect, in any one of the first to fifth aspects, the housing is formed in such a manner that the branched terminal and the unbranched terminal are insertable thereinto through the inner mating port. According to this configuration, the branched terminal and the unbranched terminal can be inserted into the housing through the inner mating port. Therefore, the branched terminal and the unbranched terminal can be mounted in the same direction in the housing regardless of the sizes of the terminals. Moreover, the inner mating port is larger than each of the outer mating ports. Therefore, the branched terminal and the unbranched terminal can be easily inserted through the inner mating port as compared to a configuration where the branched terminal and the unbranched terminal are inserted through the outer mating ports.

According to an eighth aspect of the present disclosure, a connector assembly includes: a relay connector (10) to be mounted on a casing of an electronic apparatus; one internal connector (40) placed inside the casing; and n external connectors (70) placed outside the casing, in which the relay connector connects the internal connector and the external connectors, and includes a housing, an unbranched terminal (signal terminal 36), and a branched terminal (positive power terminal 31, a negative power terminal 32), the housing includes one inner mating port (12) to be mated to the one internal connector, and n outer mating ports (13) to be mated to the n external connectors, one contact portion (38a) of the unbranched terminal is located in the one inner mating port, and the other contact portion (38b) of the unbranched terminal is located in any of the n outer mating ports, one contact portion (34a) of the branched terminal is located in the one inner mating port, and the n-branched other contact portions (34b) of the branched terminal are located in associating ones of the n outer mating ports respectively, and the unbranched terminal connects a terminal (61) of the one internal connector and a terminal (85) of any of the n external connectors one-on-one, and the branched terminal connects a terminal of the one internal connector and terminals of the n external connectors one-on-n. According to this configuration, the one internal connector is mated to the one inner mating port of the relay connector, and the n external connectors are mated to the n outer mating ports of the relay connector. The one relay connector connects the one internal connector and the n external connectors and therefore the number of connectors can be reduced. Moreover, the terminal of the one internal connector is electrically connected one-on-one to the terminal of one external connector via the unbranched terminal, and another terminal of the one internal connector is electrically connected one-on-n to other terminals of the n external connectors via the branched terminal. The branched terminal connects the another terminal and the other terminals one-on-n; therefore, the number of wires connected to the internal connector can be reduced.

Note that the present disclosure is not limited to the above embodiment, and all or parts of the above embodiment and modifications may be combined.

Moreover, the technology of the present disclosure is not limited to the above embodiment, and may undergo various modifications, replacements, and deformations without departing from the purport of the technical idea. Furthermore, if the technical idea can be achieved by other methods with the advance of technology or other derivative technologies, the other methods may be implemented. Therefore, the scope of claims covers all embodiments that can be included in the scope of the technical idea.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A relay connector to be mounted on a casing of an electronic apparatus, the relay connector comprising:
a housing;
an unbranched terminal; and
a branched terminal, wherein
the housing includes one inner mating port and n outer mating ports,
one contact portion of the unbranched terminal is located in the one inner mating port, and the other contact portion of the unbranched terminal is located in any of the n outer mating ports, and
one contact portion of the branched terminal is located in the one inner mating port, and the n-branched other contact portions of the branched terminal are located in associating ones of the n outer mating ports respectively.

2. The relay connector according to claim 1, wherein the unbranched terminal is a signal terminal and the branched terminal is a power terminal.

3. The relay connector according to claim 1, wherein
an exterior wall of the housing is provided with a cantilever spring-shaped mounting piece,
a distal end of the cantilever spring-shaped mounting piece is formed with a stepped slope of which a height increases in stages in a direction opposite to a direction in which the housing is mounted on the casing, and
it is configured in such a manner that upon mounting the housing on the casing, the stepped slope is pressed against an opening edge of an opening provided to the casing to prevent the housing from coming out of the opening.

4. The relay connector according to claim 1, wherein
the branched terminal includes a plate-shaped base portion to be inserted into the housing, and
the one contact portion of the branched terminal is formed in a pin shape protruding from the base portion into the inner mating port, and the other contact portions of the branched terminal are formed in a pin shape protruding from the base portion into the outer mating ports.

5. The relay connector according to claim 4, wherein
the base portion includes a pair of holding pieces protruding from the base portion into the inner mating port, and
it is configured in such a manner that upon inserting the branched terminal into the housing, the pair of holding pieces is held by a jig for mounting.

6. The relay connector according to claim 1, wherein
the branched terminal is a pair of branched terminals disposed spaced apart from each other in an up-and-down direction of the housing, and
the unbranched terminal is a plurality of unbranched terminals located between the pair of branched terminals in the up-and-down direction of the housing.

7. The relay connector according to claim 1, wherein the housing is formed in such a manner that the branched terminal and the unbranched terminal are insertable thereinto through the inner mating port.

8. A connector assembly comprising:
a relay connector to be mounted on a casing of an electronic apparatus;
one internal connector placed inside the casing; and
n external connectors placed outside the casing, wherein
the relay connector connects the internal connector and the external connectors, and includes a housing, an unbranched terminal, and a branched terminal,
the housing includes one inner mating port to be mated to the one internal connector, and n outer mating ports to be mated to the n external connectors,
one contact portion of the unbranched terminal is located in the one inner mating port, and the other contact portion of the unbranched terminal is located in any of the n outer mating ports,
one contact portion of the branched terminal is located in the one inner mating port, and the n-branched other contact portions of the branched terminal are located in associating ones of the n outer mating ports respectively, and
the unbranched terminal connects a terminal of the one internal connector and a terminal of any of the n external connectors one-on-one, and the branched terminal connects a terminal of the one internal connector and terminals of the n external connectors one-on-n.
